(19) United States
(12) Patent Application Publication
(10) Pub. No.: US 2011/0043579 A1
(43) Pub. Date: Feb. 24, 2011

(54) Combination laptop computer and printer

(76) Inventor: Frank Leppanen, Clovis, CA (US)

Correspondence Address: RICHARD A. RYAN;ATTORNEY AT LAW, 440 W. FALLBROOK AVENUE, SUITE 104, FRESNO, CA, 93711, US

(21) Appl. No.: 12/583,629

(22) Filed: Aug. 24, 2009

(51) Int. Cl. B41J 2/01

(52) U.S. Cl. 347/104

(57) ABSTRACT

A combination laptop computer and printer that is convenient, easy to use and easy to carry for printing materials from the laptop computer. In a preferred embodiment, the invention comprises a laptop computer having a lid pivotally attached to a base with a printer integrally formed with the laptop computer below the base. Alternatively, the printer may be fixedly attached or made integral with an upper surface of the lid or a bottom surface of the base to fixedly join the laptop and printer. In one embodiment, the printer has an intake slot to receive a sheet of paper, a discharge slot to discharge paper and a pull/feed mechanism that pulls the paper in, feeds the paper across the printer head of a printing apparatus and ejects the paper out the discharge slot. Preferably, the printer has a scanning mechanism to scan documents and a replaceable ink cartridge.

### CROSS-REFERENCE TO RELATED APPLICATIONS

None.

### STATEMENT REGARDING FEDERALLY SPONSORED RESEARCH

Not Applicable.

### BACKGROUND OF THE INVENTION

A. Field of the Invention

The field of the present invention generally relates to computers, particularly portable computers such as laptop computers and the like, and printers utilized with such computers. More particularly, the present invention relates to printers that are configured to be easily transported and utilized with a laptop computer. Even more particularly, the present invention relates to such computers and printers that are configured together as a single unit.

B. Background

Over the last twenty-five years or so, the personal computer has become an important and generally necessary tool that is commonly utilized for business, home, educational and recreational purposes. Initially, all personal computers were sized and configured such that the only practical manner in which to use the computer was at the user's desk or other fixed location. These computers, commonly referred to as desktop computers, utilized separate and somewhat bulky monitors, keyboards, printers and other peripheral devices that rendered the computer essentially non-portable. Relatively early in the history of computers, however, certain companies determined it would be beneficial to be able to selectively move the computer from the location where they were normally used to places away from the office or home in order to allow the user to have the benefits of the computer at a location “remote” from his or her desk. As a result, the computer industry developed portable computers, which are now commonly referred to as laptop computers. The portability of a laptop computer allows the user to perform tasks on the computer in many non-traditional work locations, including at a client's or customer's place of business or home, in a car, truck, boat, RV or other vehicle and at an outdoor job site, a sporting event or a wide variety of other non-traditional computing locations, including couches, parks, coffee stores and the like. The size, weight, functionality and capability of laptop computers has significantly, and likely permanently, altered the way many people interact with and utilize their computer.

While laptop computers greatly improve the ability of the user to perform computer-related tasks away from his or her desk, whether in a typical office setting or in the home, there are known issues with regard to using a remote use of a laptop computer. As is well known, the use of any computer, including laptop computers, generally benefits by being able to utilize various peripheral equipment and work materials with the computer. For instance, many people find it useful to connect the laptop computer to a printer so that he or she may print documents, including but not limited to forms, receipts, designs, bids, contracts and the like, at the remote location. Transporting the laptop computer and a printer, as well as all of the necessary cables, paper and other accessories to the desired location can be quite cumbersome. Although the user could connect the laptop computer to a printer at the remote location, assuming there is one available, it is well known that various compatibility, connectivity and security issues often preclude this option. In some settings, such as when the user is using the laptop computer in his or her home (i.e., on the couch while watching television), the user's laptop can connect wirelessly to a printer that is part of a wireless network. However, this generally requires specially configured printers and a previously configured wireless network capable of providing this feature. In practice, most people who desire or need to print a document or other material from a laptop computer will either wait until it is connected to their normally used (e.g., desktop) printer, move the laptop computer to the printer or print/store the document to a file for later printing.

None of the above-described options are very convenient and some are not practical depending on the situation where the document is needed. For instance, if the laptop user is a salesman, real estate agent or the like and he or she is meeting with a person who is ready to sign a contract if it can be printed, the inability to immediately print the contract out can result in a postponement or even a loss of the sale. As another example, a person attending a meeting, court hearing, legislative session or the like who forgot to bring an important document can have the document emailed to him or her, but cannot print it without having to ask others for assistance in locating an appropriate printer (if even available). As yet another example, a person perusing the Internet who sees something that he or she wants to keep, such as information regarding a product or property, must either move the laptop computer to a printer or store the information on the laptop computer for later printing, assuming he or she does not forget that the material is on the laptop computer. Numerous other examples of the need for having a printer readily associated with a laptop computer can also be identified.

Various portable printers have been available for use with laptop computer and other portable computing devices. Many of the printers that are marketed or otherwise identified as being portable derive their alleged portability from the fact that they are powered by or may be selectively powered by internal batteries. As is readily apparent to those who utilize such printers, having a printer that is free from the need to connect to an outlet does not necessarily make the printer easy to transport. In fact, many of the so-called portable printers are relatively heavy and bulky, such that transporting the printer with a laptop computer requires the user to handle a separate, often odd-shaped carrying case. This typically results in the user having to carry his or her laptop computer in a computer-compatible case, usually in the form of an expanded briefcase or the like, and carry the printer in its own separate carrying case. One advantage, however, of these larger-sized portable printers is that they are configured to print documents on the standard 8½″ by 11″ letter sized paper. Some of these printers are also capable of printing on legal sized or larger sized paper.

More recently, the computer industry has developed portable printers which are lighter, smaller and less bulky, making them much easier to transport and use with laptop computers. One such printer is the Pocketjet® 3 mobile printer from Pentax. This printer utilizes thermal printing technology, weighs approximately four pounds, has dimensions of 2.2″ by 10″ by 1.2″ and utilizes built-in rechargeable nickel-metal hydride (NiMH) batteries. Due to its length, this printer is capable of printing documents on full size letter, legal and A4 thermal paper. The paper is fed into the portable printer one sheet at a time or supplied in a continuous or perforated roll. The printer connects to the user's laptop or other computer via USB cable or integrated Bluetooth® technology. Companies such as Brother, Fuji and Sony are marketing very small portable printers that, like the Pentax printer, generally rely on thermal printing technology to produce the printed document. Typically, these printers are hand-held devices that print documents or photographs on smaller sized paper, such as the postcard sized A6 paper, 4″ by 6″ photograph paper or card-sized paper. Due to their size, they are generally not suitable for printing documents on letter or larger sizes of paper. In addition, while the small size of the smaller portable printers has advantages with regard to transportability, they are not necessarily easy to utilize in the field, on a job site or other locations where handling and placement of the small, separate printer creates its own difficulties.

In addition to the foregoing, various portable printers have been the subject of issued patents. For instance, U.S. Pat. No. 5,209,583 to Lewis, et al. describes a compact printer for portable teletransaction computers or data terminals that comprises a computer receiving well which restricts the orientation of the computer when the computer connector is being engaged by the printer connector. U.S. Pat. No. 7,036,925 to Fujiwara describes a very small printer that has hooks which hook on to the top of the display panel of a laptop computer and a housing configured to hold A6 or A7 size paper. U.S. Pat. No. 6,626,597 to Fujiwara describes a thin, compact printer that utilizes thermal technology to print on paper which is fed into the printer. As described above, individual sheets or rolled sheets of paper are fed into the printer feed mechanism. U.S. Pat. No. 6,219,227 to Trane describes a portable computer assembly having the laptop computer incorporated therein such that the paper tray is positioned below the computer keyboard and processor, a printing device is attached to the side of the computer to receive paper from the paper tray and the computer monitor is incorporated into the cover lid. A portable telephone is releasably secured to the main outer casing and electrically connected to the computer.

While the various portable printers somewhat solve the problem of having a printer available when using a laptop computer away from a desk or other location, well known limitations to these printers have significantly limited their popularity and use. As a result, if a person using a laptop computer desires or needs to print a document or other material he or she will typically either move the laptop computer to a location where a printer can be connected or will store the file for later printing. What is needed, therefore, is an improved system of printing documents from a laptop computer. Preferably, such a system will be easy to transport and use with the laptop computer without requiring the user to have to handle multiple components and connect multiple cables and wires. In a preferred configuration, the printer will be always readily available for use with the laptop computer, thereby eliminating the need for the user to move to a printer or store the document for later printing. The improved system of printing documents from a laptop computer should allow the user to directly print a document from the laptop computer when he or she needs or desires such printing so the user can avoid missing an opportunity to accomplish a desired objective, whether it is a sale, to support a position or to inform another person. The preferred printer should be suitable for use with various available printing mechanisms, including but not limited to ink jet, laser, thermal and other printing devices and be configured to allow the user to print full, letter sized documents.

### SUMMARY OF THE INVENTION

The laptop computer and printer of the present invention solves the problems and provides the benefits identified above. That is to say, the present invention discloses a combination laptop computer and printer in which the printer is integral with the laptop computer, either below the keyboard and computing portion of the laptop computer or with its lid, or the printer is fixedly attached to the top or bottom surface of the laptop computer and is electronically connected to the laptop computer so the printer functions directly with the laptop computer as in integral component. In a preferred embodiment, the printer is configured to accept and print on letter sized paper, though it may accept envelopes or smaller sized paper also, which is received and discharged through slots on opposite sides of the printer. Preferably, the printer portion of the combination is sized and configured such that it appears to be part of the laptop computer and to fit within the boundaries of the surface of the laptop computer so the combination does not exceed the length and width dimensions of the laptop computer. In a preferred embodiment, the combination laptop computer and printer is configured to be relatively lightweight and small in size so as to be easily portable and fit inside a typical laptop carrying case, briefcase or similarly sized conventional case. The laptop computer and printer of the present invention is adaptable for use with a variety of different types of printing devices, including but not limited to thermal transfer, ink jet, laser and thermal printing mechanisms. The laptop computer and printer allows the user to easily and quickly print documents or other materials from the printer.

In a preferred embodiment of the present invention, the combination laptop computer and printer generally comprises a laptop computer and a printer that are integrally joined together with the printer disposed below the computer components of the combination. As with standard laptop computers, the laptop computer used with the combination of the present invention has a base, a lid that is pivotally attached to the base, an on/off device, a power receptacle and a variety of user and media interface devices, including USB ports, CD/DVD trays, Internet connection ports and the like that are in the computing portion of the combination. Preferably, the combination laptop computer and printer of the present invention are configured such that the combination appears very similar to a conventional laptop computer, except that it has a thicker bottom portion that provides the space for the printer components of the printer. The printer has an intake slot on its first end, a discharge slot on its opposite facing second end, a printing apparatus that is disposed between the first end and the second end and that is configured to print on a sheet of paper and a pull/feed mechanism that is configured to pull the sheet of paper into the printer through the intake slot, feed the sheet of paper to the printing apparatus and then eject the sheet of paper out of the printer through the discharge slot. Preferably, the intake and discharge slots are at least 8½″ wide, so the user can print materials on standard letter or legal sized paper, and have a paper adjustment mechanism that allows the user to insert and print on envelopes, labels, smaller sized paper and the like. In a preferred configuration, the on/off device activates the laptop computer and the printer and the power receptacle connects the laptop computer and the printer to a source of power, such as a standard outlet. The source of power is utilized to recharge a battery inside the combination that is utilized to provide power to both the laptop computer and the printer. Preferably, the printer includes a scanning mechanism disposed between the intake and discharge slots that is configured to selectively scan documents or other materials inserted into the printer through the intake slot. Various printing apparatuses and pull/feed mechanisms can be utilized with the combination laptop computer and printer of the present invention. In a preferred embodiment, the printer apparatus comprises a printer head and a replaceable source of ink and the pull/feed mechanism comprises a plurality of rollers configured to engage the sheet of paper as it moves through the printer. Preferably, the source of ink is an ink cartridge, such as the ribbon type cartridge utilized with thermal transfer printing mechanisms, that is removably received in an ink compartment disposed in the printer. Slots on the front and back sides of the combination provide air intake for the fan used to cool the laptop computer. The combination laptop computer and printer of the present invention is a single unified computing/printing apparatus that allows the user to quickly and easily print documents, drawings, photographs and other materials from the laptop computer without having to locate an available and compatible printer and without having to carry and the connect a separate portable printing device. As such, users will find the present invention to be much more convenient and easy to use than presently available apparatuses.

In an alternative embodiment, the laptop computer and the printer are two separate components that are fixed joined together and electronically joined together to function as a single unit. In one configuration of the alternative embodiment, the upper wall of the printer is fixedly attached to the downwardly disposed lower surface of the laptop computer. In another configuration, the lower wall of the printer is fixedly attached to or integral with the upwardly disposed upper surface of the lid. In either configuration, the front side of the printer is preferably in corresponding relation to the front side of the laptop computer, disposing the intake and discharge slots on the narrower left and right ends of the computer. In another alternative embodiment, which is applicable to any of the integral or attached embodiments described above, the paper can feed from the front to the back or it can feed from the back to the front, with the intake and discharge slots being appropriately positioned for the printer. In another alternative embodiment, which is also applicable to all the above embodiment, the combination laptop computer and printer includes a paper tray that allows the user to store paper for use by the printer. The paper tray can be configured to directly feed the stored paper to the printing apparatus or the paper tray can be merely a storage tray that requires the user to manually feed the paper into the intake slot by the user.

Accordingly, one of the primary aspects of the present invention is to provide a combination laptop computer and printer that has the advantages discussed above and overcomes the disadvantages and limitations associated with presently available laptop computer and portable printer systems.

It is also an important aspect of the present invention to provide a combination laptop computer and printer that has the printer integral with the laptop computer or fixedly attached to the surface of one of the sides of the laptop computer to provide easy and quick printing capability at any time from the laptop computer.

It is also an important aspect of the present invention to provide a combination laptop computer and printer that are integrally and electronically joined to function as a single unit with the printer able to receive and print on letter sized paper.

It is also an important aspect of the present invention to provide a combination laptop computer and printer having a printer that is adaptable for use with a variety of different types of printing devices, including but not limited to thermal transfer, ink jet, laser and thermal printing mechanisms.

Another important aspect of the present invention is to provide a combination laptop computer and printer that can be easily transported in a computer carrying case, briefcase or like cases.

Yet another important aspect of the present invention is to provide a combination laptop computer and printer that allows the user to directly print a document from the laptop computer without having to connect any peripheral devices when he or she needs or desires such printing.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a front view of a combination laptop computer and printer configured according to a preferred embodiment of the present invention shown with the laptop computer in the closed position;

FIG. 2 is a left or first side view of the combination laptop computer and printer of FIG. 1 showing the printer's intake slot;

FIG. 3 is a right or second side view of the combination laptop computer and printer of FIG. 1 showing the printer's discharge slot;

FIG. 4 is a back view of the combination laptop computer and printer of FIG. 1;

FIG. 5 is a back cross-sectional view of the printer taken through lines 5-5 of FIG. 4;

FIG. 6 is an alternative embodiment of the combination laptop computer and printer of FIG. 1 showing use of a paper tray;

FIG. 7 is a top perspective view of alternative embodiment of the combination laptop computer and printer of the present invention showing the printer attached to the lid of the laptop computer, which is in the closed position;

FIG. 8 is a front view of the combination laptop computer and printer of FIG. 7 shown with the laptop in its open position with a sheet of paper being fed into the printer;

FIG. 9 is a front view of the combination laptop computer and printer of FIG. 7 shown with the laptop in its open position with the sheet of paper being discharged from the printer after printing thereon;

FIG. 10 is a left or first side view of the combination laptop computer and printer of FIG. 7 showing the printer's intake slot;

FIG. 11 is a right or second side view of the combination laptop computer and printer of FIG. 7 showing the printer's discharge slot;

FIG. 12 is a back view of the combination laptop computer and printer of FIG. 7;

FIG. 13 is a side view of an alternative embodiment of the present invention showing the paper being fed into an intake slot located at the front of the printer;

FIG. 14 is a right or second side view of an alternative embodiment of the combination laptop computer and printer showing the printer attached to the bottom of the laptop computer; and

FIG. 15 is a back view of the combination laptop computer and printer of FIG. 14.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed description and drawings set forth and illustrate one or more of the preferred embodiments and, as such, represent one or more ways of configuring the present invention. Although specific components, materials, configurations and uses are illustrated, it should be understood that a number of variations to the components and to the configuration of those components described herein and in the accompanying figures can be made without changing the scope and function of the present invention. For instance, although the various figures and the description provided herein are directed to certain configurations of a laptop computer and certain size relationships between the laptop computer and the printer, those skilled in the art will readily understand that this is set forth merely for purposes of simplifying the present disclosure and that the present invention is not so limited.

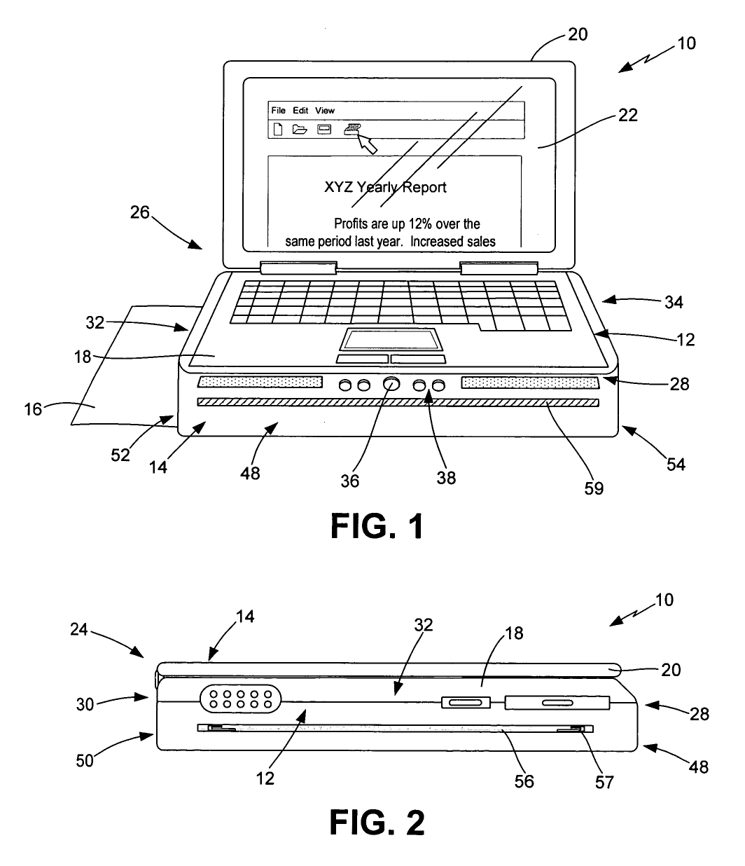

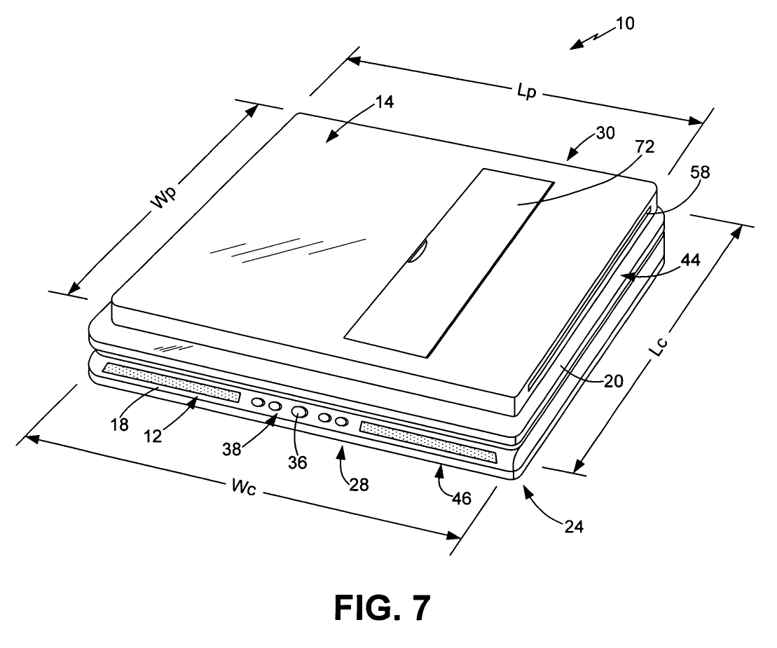

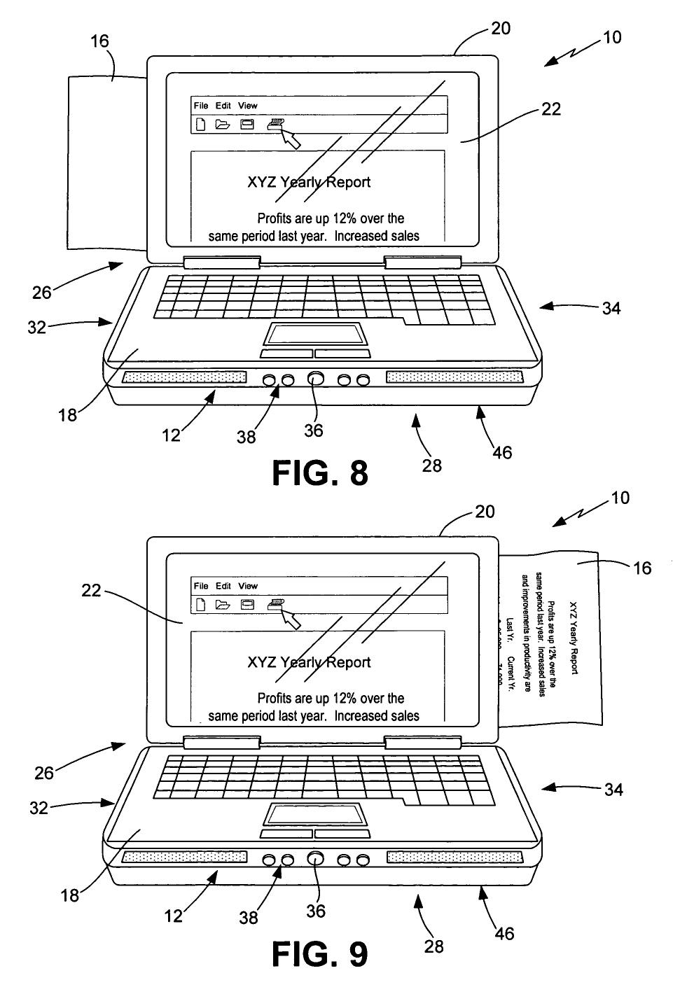

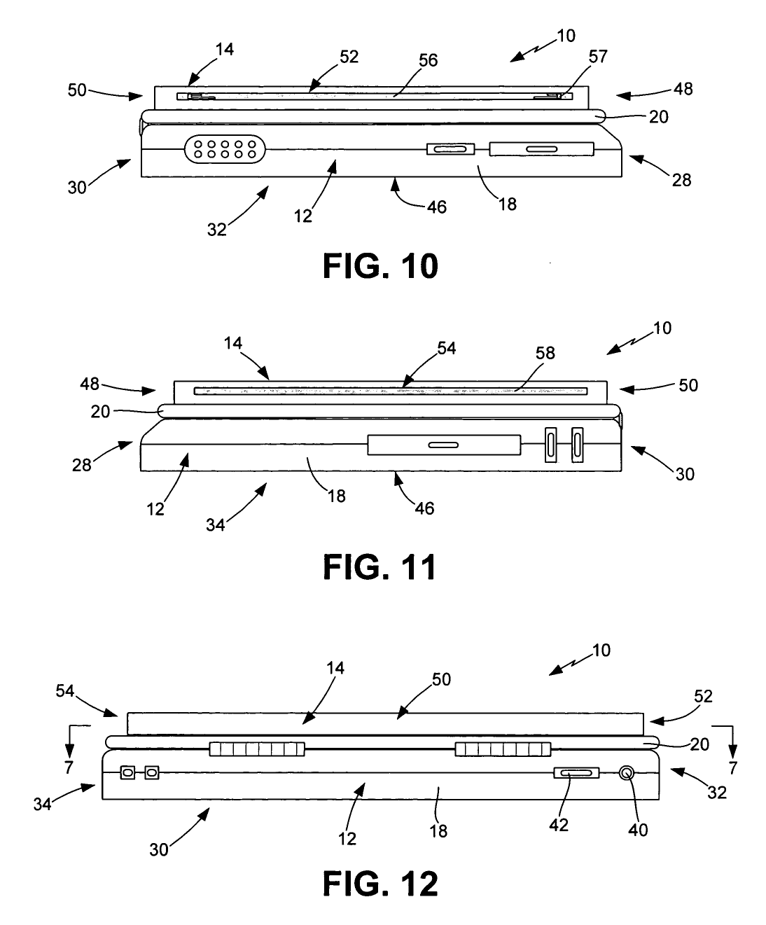

A combination laptop computer and printer that is manufactured out of the components and configured pursuant to various preferred embodiments of the present invention is shown generally as 10 in the figures. The combination laptop computer/printer 10 generally comprises a laptop computer 12 having a printer 14 integrally formed therewith or attached thereto for printing on a sheet of paper 16 that is fed into the printer 14, as shown in FIGS. 1, 8, and 13, and then discharged from printer 14, as shown in FIG. 9, for use by the user of laptop computer/printer 10. In the embodiments of FIGS. 1 through 6, the laptop computer 12 and printer 14 are integrally formed such that, to the user, the combination laptop computer and printer 10 has an appearance that is very similar to a conventional laptop computer 12, except it has a thicker bottom portion that contains the printer 14 and its associated components. In the embodiments of FIGS. 7 through 13, the printer 14 is fixedly attached to the top of the laptop computer 12. In the embodiments of FIGS. 14 and 15, the printer 14 is fixedly attached to the bottom of the laptop computer 12. As set forth in more detail below, for each of these different embodiments the laptop computer 12 and printer 14 are integrally/fixedly configured to be transported and used together and electronically joined so no additional cables, wires or other connectors are necessary to electronically transfer information between the laptop computer 12 and printer 14 or for the power supply to operate the combination 10.

As well known in the art, laptop computer 12 generally comprises a base 18 containing the computing components and a lid 20 having a display screen 22 on which information from the computing components of base 18 is displayed. The upper surface of base 18 also contains the various user interface components, such as an alphanumeric keyboard, scrolling device, function keys and other keys and/or buttons, and encloses the battery, fan, hard drive and other components necessary for computer utilization of laptop computer 12. Although the present invention is generally described herein as having a conventional laptop computer 12, the laptop computer/printer 10 can be configured for use with a variety of non-standard laptop computers and other portable computing devices or devices having computer-like capability. As such, the term “laptop computer” is intended to incorporate such portable computing devices. In addition, as set forth below, a variety of other portable computing devices, such as PDAs, cellular telephones and the like, can be operatively connected to laptop computer 12 or printer 14 to print documents, emails, graphs, figures and other materials from the portable computing device. Although not particularly advantageously utilized therewith, the laptop computer/printer 10 can be operatively connected to a conventional desktop computer system (not shown) to print documents or other materials generated by such a system, generally when no other printer is available.

As well known in the art, the lid 20 is hingedly attached to the base 18 so the user can pivotally open or close the lid 20 to move the laptop computer 12 between its closed position 24, shown in FIGS. 2-4, 7, 10-12 and 14-15, and its open position 26, shown in FIGS. 1, 8, 9 and 13. In the open position 26, the user has access to the various user interface devices and can view items on the display screen 22. The laptop computer 12 has a front side 28, back side 30, left or first side 32 and a right or second side 34. Except with regard to being integral or attached to printer 14 and its electronic connections thereto, laptop computer 12 functions in a manner very familiar to those skilled in the art. Typically, but not exclusively, laptop computer 12 has an on/off device 36, which usually is a button or switch, and a variety of other control buttons, switches and the like, which are collectively identified as the controls 38 on the front side 28, as shown in FIGS. 1, and 7 through 9. The back side 30 of laptop computer 12, best shown in FIGS. 4, 12 and 15, often includes a power receptacle 40, one or more network connector ports and/or other desirable plugs and ports (e.g., a USB port 42). Typically, the power receptacle 40 is configured to receive a wired plug that connects the laptop computer 12 with a source of electricity, such as an electrical outlet, for providing power to operate laptop computer 12 and to recharge the battery inside base 18. As best shown in FIGS. 2, 3, 10, 11 and 14, the typical laptop computer 12 also has one or more plugs or ports, including a monitor plug and USB ports, and a CD/DVD tray located on the first side 32 and/or the second side 34 of laptop computer 12. A securing mechanism secures the lid 20 to the base 18 when the laptop computer 12 is in its closed position 24. As will be readily appreciated by those skilled in the art, the various operating and useful devices associated with laptop computer 12, such as the on/off device 36, controls 38, power receptacle 40, and USB port 41, can be located on other sides or surfaces than those shown in the figures and identified above. As best shown in FIG. 7, the lid 20 of laptop computer 12 has an upper surface 44 and the base 18 has a lower surface 46. The upper surface 44 and lower surface 46 are generally or substantially planar across the length Lc and width Wc of laptop computer 12, except for a plurality of small cushioned pads or “feet” and access panel tabs which are typically found on bottom surface 46 of base 16 of laptop computer 12.

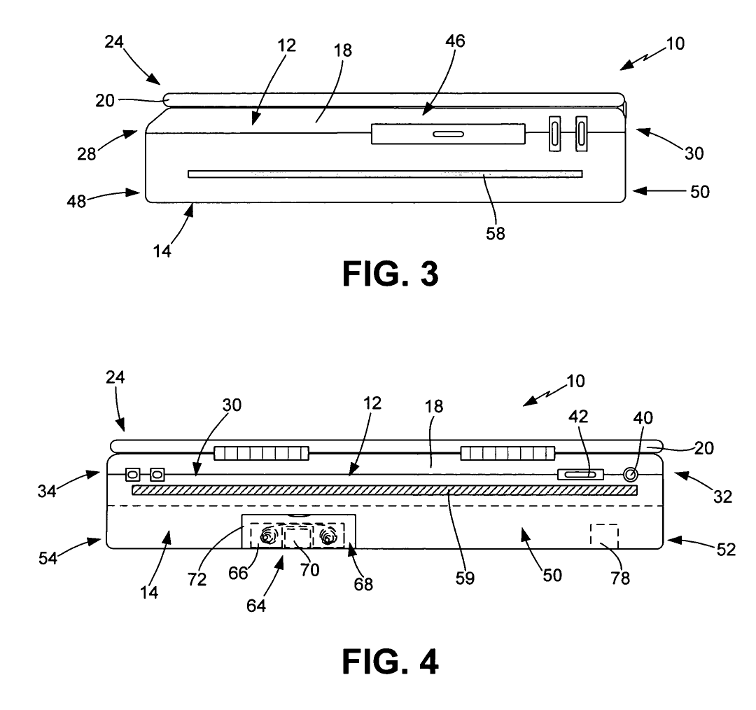

As shown with regard to the embodiment of FIGS. 1 through 6, the printer 14 (which is shown integrally formed with the laptop computer 12) has a front side 48, back side 50, left or first end 52 and a right or second end 54, with the front, back, left and right designations corresponding to those of the laptop printer 12. In the embodiment shown in the figures, the sheet of paper 16 moves through printer 14 from the first end 52 to the second end 54 (i.e., left to right). Printer 14 has an intake slot 56 at the first end 52 and a discharge slot 58 at the second end, as best shown in FIGS. 2 and 3. The intake slot 56 and discharge slot 58 are both sized and configured to accept standard width paper 16, which is typically 8½″ wide for letter and legal size papers. In a preferred embodiment, the printer 14 includes a paper size adjusting mechanism 57 at the intake slot 56 to allow the user to effectively adjust the width of the intake slot 56 for different sizes of paper 16, such as is commonly provided for use in printing envelopes, labels, postcards, note cards, smaller paper sizes and the like. As set forth in more detail below, the paper 16 is inserted by the user into the intake slot 56 of printer 14, pulled through and acted on (printing) by the printer 14 and then ejected through discharge slot 58 to the user. Typically, the front side 48 and back side 50 of the portion of the combination 10 housing the printer 14 will either be substantially planar or have one or more receptacles or ports that may be beneficial for use of printer 14. In addition, both the front side 48 and back side 50 of this embodiment have one or more fan intake vents 59 to facilitate the fan of laptop computer 12 pulling in ambient air to cool the components of the laptop computer 12. If desired, the fan intake vents 59 can also be utilized to cool the components of printer 14. The internal components of printer 14 are contained by the sides 48/50 and ends 52/54 below the base 18 of the laptop computer 12 that contains the computing components of laptop computer 12.

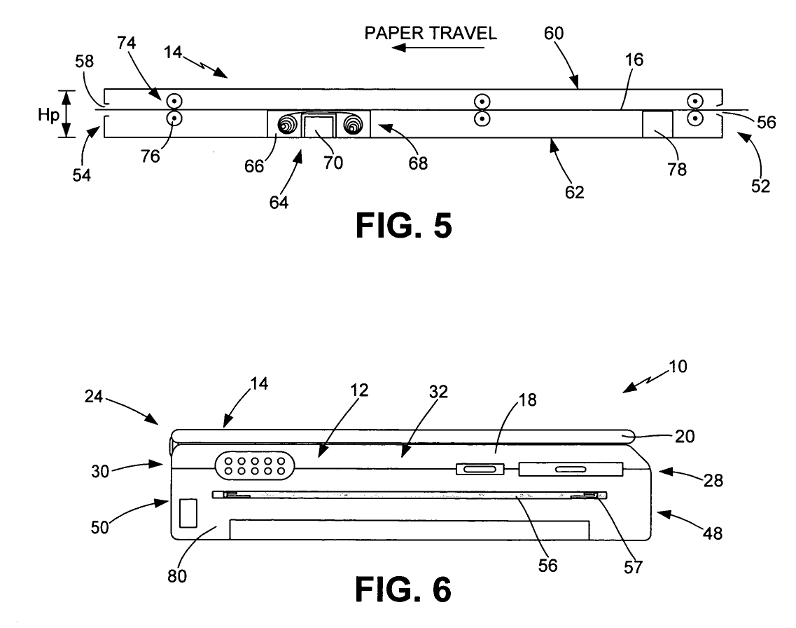

Various types of printing apparatuses, shown generally as 64 in FIG. 5, are suitable for printer 14 of the laptop computer/printer 10 of the present invention. For instance, the printing apparatus 64 can be one of the conventional types of apparatuses, such as a thermal transfer printer, inkjet printer, laser printer, impact printer or direct thermal printer. As known to those skilled in the art, each of these types of printing apparatuses 64 have advantages and disadvantages. For instance, thermal transfer, inkjet and laser printers typically produce better quality printing and print on standard paper compared to direct thermal printers, which requires special paper. A disadvantage of the thermal transfer, inkjet and laser printers is that they require a replaceable supply of ink, typically provided in the form of an ink cartridge 66 (which may be a printer ribbon or contain liquid or powered ink) or the like. In the preferred embodiment of laptop/printer 10 of the present invention, the printing apparatus 64 utilizes thermal transfer technology to print on paper 16. As well known in the art, such printing apparatuses 64 utilize an ink cartridge 66 that contains a ink coating which is, in effect, melted onto the paper 16 by printer head 70 (which is a thermal print head) to form the desired words, images or the like on paper 16. One of the advantages of using a thermal transfer mechanism as the printing apparatus 64 is the small size in which the printer 14 can be contained. However, as set forth above, the present invention is not limited to this type of mechanism as the printing apparatus 64. As well known in the art, the different types of printing apparatuses 64 are also likely to have different sizing and power requirements that may make one type of printing apparatus 64 preferred over another. Depending on the desired characteristics of laptop computer/printer 10 of the present invention, however, each of these may be suitable for use in printer 14. In addition, less commonly available or new printing apparatuses may also be suitable for use. For instance, Zink Imaging, Inc. has developed a new type of printer that does not require ink, referred to as “zink” for zero ink. The printer and printing process, described at www.zink.com, utilizes specially formulated paper having crystals that are activated by heat from the printer to generate black/white and/or color print on the paper. In addition to the foregoing printing apparatuses 64, which are set forth herein for exemplary purposes, a variety of other printing apparatuses 64 may also be suitable for use with laptop computer/printer 10.

If the printing apparatus 64 of printer 14 requires one or more replaceable ink cartridges 66, such as the ribbon for thermal transfer, then the laptop computer/printer 10 should be configured with an ink compartment 68, as shown in FIG. 5, that positions the ink cartridge 66 in communication with the printer head 70 of the printing apparatus 64 to supply ink thereto for transferring images to the paper 16. Preferably, the ink compartment 68 will have a door or panel 72 (shown in FIGS. 4 and 7) that either opens, pivots or otherwise opens or is removable so the user can replace ink cartridge 66 as necessary to maintain the desired quality of printing from printer 14. As shown in FIGS. 4 and 7, the panel 72 can be at the back side 50 of printer 14 or in the upper wall 60 of printer 14. Alternatively, the combination laptop/printer 10 can be configured so the ink cartridge 66 can be removed through the front side 48 or one of the ends 52/54 of printer 14.

The printer 14 of the laptop computer/printer 10 of the present invention shown in the figures comprises a pull/feed mechanism 74 having a plurality of rollers 76, shown in FIG. 7, that are configured to pull a single sheet of paper 16 in through the intake slot 56, feed the sheet of paper 16 through the printer 14 and over the printer head 70 so it may print on the sheet of paper 16 and then eject the sheet of paper 16 out of the printer 14 through discharge slot 58. In the preferred embodiment, printer 14 includes a printer head 70 that prints on the sheet of paper 16, an ink cartridge 66 or other source of ink, a pull/feed mechanism 76 to pull in and eject a sheet of paper 16 and any other components that may be necessary for printer 14 to print on the sheet of paper 16. In the preferred embodiment of the present invention, the power source for the printer 14 is connected to the power source of the laptop computer 12, such that the power receptacle 40 is utilized to power the laptop computer 12 and the printer 14. The battery of the laptop computer 12 powers both devices and is recharged by connecting the power receptacle 40 to an electrical outlet or other source of power. Preferably, the laptop computer 12 (and, therefore, printer 14) will utilize one or more long lasting lithium-ion batteries. Although other battery systems, including but not limited to nickel-metal hydride and nickel-cadmium batteries may be utilized, these batteries generally do not have the long life advantages of lithium-ion batteries.

In the preferred embodiment of the laptop computer/printer 10 of the present invention, the printer 14 is directly electrically connected to the laptop computer 12 so no wires, cables or other devices are necessary to transfer commands from laptop computer 12 to printer 14 or information back to the laptop computer 12. In this manner, the user will not need to connect anything to the printer 14 to begin use thereof. The on/off device 36 of laptop computer 12 can be connected to the printer 14 such that when the user powers up the laptop computer 12 he or she will also be powering up the printer 14. Preferably, the printer 14 will come on and then go into a “sleep” mode until a sheet of paper 16 is inserted into the intake slot 56, at which time the printer 14 will activate the pull/feed mechanism 74 to pull the paper 16 in, move it through the printer 14 and eject it out the discharge slot 58. If desired, printer 14 can include a separate on/off switch that will allow the use to keep the printer 14 in the “powered down” mode until he or she desires to print a document from the printer 14. Although generally not preferred, alternatively various types of communication mechanisms can be utilized with the laptop computer/printer 10 of the present invention to operatively connect the printer 14 to the laptop computer 12 so that electronic signals transmitting printing information may be sent from the laptop computer 12 to the printer 14 to print a document or other material (i.e., photographs, drawings, forms and etc.). In one configuration of this embodiment, the communication mechanism can be one of the USB ports, such as USB port 42 on laptop computer 12. Alternatively, the communication mechanism can be a variety of other hardwire devices, such as a printer cable, firewire cable or a variety of other types of wire-type connectors available in the electronics industry to connect a peripheral device, such as a printer, to a computer.

In another embodiment, the connection mechanism for the laptop computer/printer 10 can be a wireless connection, which eliminates the need to have a cable, including USB cable, interconnecting the laptop computer 12 and printer 14, thereby eliminating the need to carry and keep track of the cable and the clutter associated with use of a cable. A variety of wireless digital or analog interfaces or connection systems are available for wirelessly connecting laptop computer 12 to the printer 14. One type of such wireless communication is the use of infrared (IrDA) light transmitters and receivers. Such devices are of limited acceptability, however, due to directional and visual problems that are known to exist with IrDA systems. Until relatively recently, the most common configuration for short range RF systems has been the IEEE 802.11 (or Wi-Fi) based radio frequency. To provide more secure and functional wireless transmission between closely positioned devices, the communications industry developed Bluetooth® (which is a trademark owned and controlled by Bluetooth SIG, Inc.) as a wireless technology standard that utilizes the unlicensed 2.4 Ghz radio spectrum. In a relatively short period of time, the Bluetooth® standard for wireless piconet systems has become very well known. Information about Bluetooth® is available from many different sources, including from the Internet at www.bluetooth.com. In general, Bluetooth® network technology is an open, worldwide specification for wireless communication of data and voice that is based on a low-cost, short-range radio link which allows wireless communication over a typical range of up to approximately 100 feet. As well known, Bluetooth® technology has been incorporated into a variety of devices for various uses, including as a wireless interface between computers and their associated printers. For the reasons set forth above, therefore, the presently preferred communication mechanism is the Bluetooth® technology. It is anticipated that, over time, improved communication mechanisms may be developed by the computer industry to replace Bluetooth® technology as the preferred communication mechanism.

In each of the embodiments of the laptop computer/printer 10 of the present invention, one of the primary benefits is that the combination of the laptop computer 12 and printer 14 can be made with a very low profile, particularly relative to existing printers, and still print on standard sizes of paper. The low, relatively flat profile of laptop computer/printer 10 allows it to be easily carried and/or stored in a briefcase or standard laptop case. In one embodiment, the height Hp of printer 14 is approximately ¾″ to 1″, providing an overall height of approximately 2½″ to 3″ for laptop computer/printer 10. The components for printer 14 should be selected so as to be relatively lightweight so the overall weight of the laptop computer/printer 10 of the present invention is not difficult for the average person to carry.

In the preferred embodiment of the laptop computer/printer 10 of the present invention, the printer 14 is dimensioned so as to be the same or at least slightly smaller than the dimensions of the laptop computer 12. Specifically, the width Wp of printer 14 should be the same or smaller than the width Wc of the laptop computer 12 and the length Lp of printer 14 should be the same or, preferably, smaller than the width Lc of the laptop computer 12. As such, the printer 14 will not result in an overall increase in the width and length size for laptop computer/printer 10. Although the overall height will be greater, selecting a printer 14 having a relatively low height Hp will provide a profile for laptop computer/printer 10 that will be acceptable to the vast majority of laptop users, particularly in light of the benefits provided by the present invention.

The preferred embodiment of laptop computer/printer 10 of the present invention also includes a scanning mechanism 78, best shown in FIG. 5, that will selectively scan a document that is fed into intake slot 56 as it is drawn over the scanning mechanism 78 by the rollers 76 of the pull/feed mechanism 74. In one embodiment, the initiation and operation of scanning mechanism 78 is controlled by software provided on the laptop computer 12, such that the user initiates the scanning of a document through commands entered on the laptop computer 12 at one or more of the human interface devices. Alternatively, the printer 14 can comprise a separate on/off switch or button for the scanning mechanism 78 that allows the user to scan a document without turning on the laptop computer 12 and printer 14. In this embodiment, the user would activate the on/off switch and insert a document to be scanned into the intake slot 56. The scanning mechanism 78 would scan the document and store it in the printer 14 or on a separate memory card that could be inserted into the printer 14 at a slot provided for such a card. This would allow the user to quickly scan and save the scanned image without waiting for the laptop computer 12 and/or printer 14 to power up. If desired, the user could later print the scanned document from the printer 14. Various alternative scanning operations can also be performed.

In an alternative embodiment of the present invention, the laptop computer/printer 10 also includes a paper tray 80, as shown in FIG. 6, disposed below the printer 14 that can be utilized to store paper 16 for use by printer 14. The configuration and use of paper trays are generally well known to those skilled in the art. In one configuration, paper tray 80 is of the type that merely allows the user to store one or more sheets, preferably a plurality, of paper 16 with laptop computer/printer 10 so that he or she may have it readily available for use to feed into the intake slot 56 of printer 14. The paper tray 80 can be of the type that has a portion which slides out from under the printer 14 or it can be of the type that is merely an open chamber below the printer 14 that has a door or door-like device which closes the chamber to enclose the paper 16 therein until the user is ready to print. In another configuration of this embodiment, the paper tray 80 can be of the type that contains a mechanism for selecting one sheet of paper 16 from the paper tray 80 and then feeding the paper 16 through the printing apparatus 64 so that it may be printed on. Such mechanisms, which are well known in the art, may require a deeper paper tray 80, which could increase the overall height of the laptop computer/printer 10. Although many users may find paper tray 80 to be useful, either configuration is likely to increase and the cost and complexity of the laptop computer/printer 10 of the present invention.

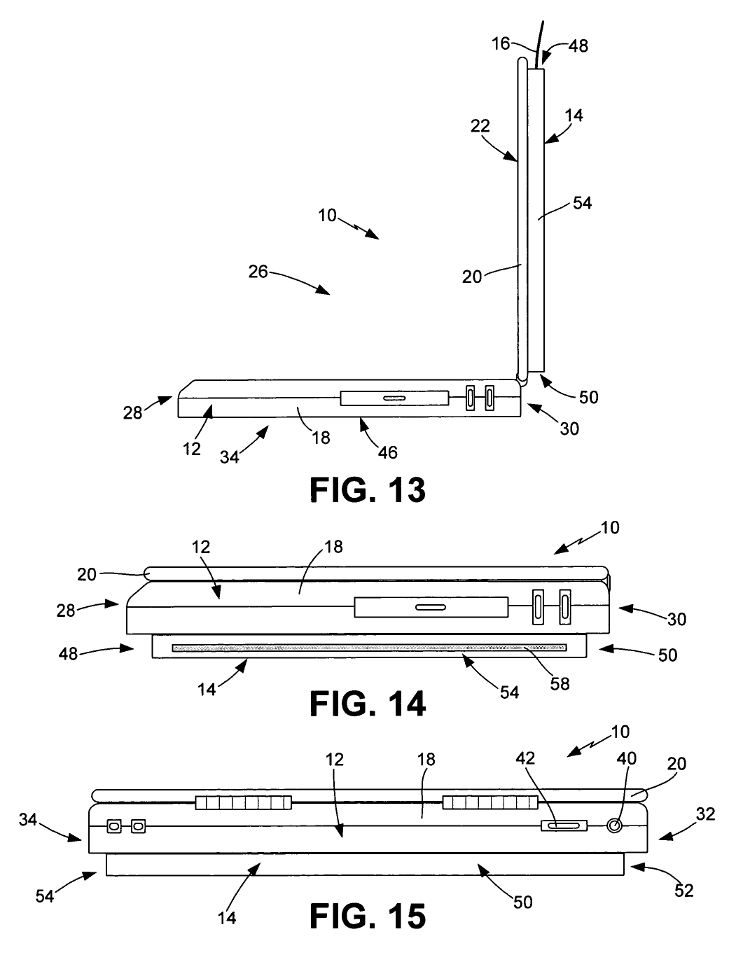

Alternative embodiment of the laptop computer/printer of the present invention are shown in FIGS. 7 through 13 and in FIGS. 14 and 15. In the embodiment of FIGS. 7 through 13, the printer 14 is fixedly attached to or made integral with the upper surface 44 of lid 20 of the laptop computer 12. In the embodiment of FIGS. 14 and 15, the printer 14 is fixedly attached to or made integral with the lower surface 46 of base 18 of the laptop computer 12. In either embodiment, the printer 14 is selected such that it has a width Wp and a length Lp which is equal to or less than the width Wc and length Lc of laptop computer 12, as shown in the figures, so none of the dimensions of printer 14 exceed any of the dimensions of the laptop computer 12. As shown in FIGS. 7 through 15, the width Wp and length Lp dimensions of printer 14 correspond in position, but not necessarily actual distance, to the width Wc and length Lc of laptop computer 12. In the embodiment shown in FIGS. 7 through 15, the upper wall 60 and lower wall 62 of printer 14 are generally planar with the lower wall 62 fixedly attached to or integral with the upper surface 44 of lid 20 (FIGS. 7 through 13) or the upper wall 60 attached to or integral with the lower surface 46 to fixedly join together the laptop computer 12 and printer 14 to form the laptop computer/printer 10 of the present invention. Preferably, as described with the embodiments of FIGS. 1 through 6, the laptop computer 12 and printer 14 are electrically and electronically interconnected so the user does not have to connect any wires or cables to have the printer 14 function with the laptop computer 12. The various other features, components and configurations of the combination 10, laptop computer 12 and printer 14 described above are applicable to the embodiments shown in FIGS. 7 through 15. If the printer 14 is attached to the lower surface 46, then the fan intake, battery door and access panels, as well as any other components that are commonly positioned on the lower surface 46 of a laptop computer 12, would need to be moved elsewhere so that the user or others on his or her behalf can have access to these components. If desired, the laptop computer/printer 10 of the present invention can be modified so the paper 16 moves from the second side 54 of printer 14 to the first side 52 of printer, which is opposite that shown in the figures. In addition, as shown with regard to the alternative embodiment of FIG. 13, the laptop computer/printer 10 can also be modified such that the sheet of paper 16 moves through the printer 14 from its front side 48 to its back side 50, with the intake slot 56 located on the front side 48 and the discharge slot located on the back side 50. In another alternative, not shown, the sheet of paper 16 can move from the back side 50 of printer 14 to the front side 48 of printer 14. The printer 14 may be fixedly attached or made integral with other sides of the laptop computer 12 than upper surface 44 of lid 20 or lower surface 46 of base 18. In another alternative embodiment, printer 14 can include one or more connection plugs or ports, such as a USB port, so the user can connect a peripheral computing device, such as a PDA, cellular phone or the like, to the printer so he or she can print a document directly from the peripheral computing device. Alternatively, the peripheral computing device can connect to the laptop computer 12, which can transfer the document to the printer 14 via appropriate software embedded on the laptop computer 12.

In use, the user would use the laptop computer 12 portion of laptop computer/printer 10 in substantially the same manner he or she would use a conventional laptop computer having a printer connected thereto. Instead of the user having to look for a printer when he or she wants to print a document or other material, all the user has to do is insert a sheet of paper 16 into the intake slot 56 and activate the printing sequence from the appropriate software. The pull/feed mechanism 74 will pull the sheet of paper 16 into the printer 14 where the rollers 74 will move the paper 16 across the printer head 70 and ejects it out the discharge slot 58. In this manner, the user can quickly and easily obtain a printed document, picture or other material and be able to accomplish his or her objectives, such as presenting a contract to a buyer or seller for execution. In a preferred embodiment, the printer 14 activates at the same time the user powers on the laptop computer 12, but remains in sleep mode until the sheet of paper 16 is placed into the intake slot 56. If the user desires to scan a document, he or she merely feeds the document into the intake slot 56, activates the scanning mechanism 78 utilizing software on the laptop computer 12 and then recovers the document after it ejects from the discharge slot 58. The small size of the laptop computer/printer 10 of the present invention will allow the user to carry it in a conventional laptop carrying case, briefcase or like case. As such, the laptop computer/printer 10 of the present invention eliminates the need for the user to locate an acceptable and compatible printer when he or she needs to print a document or other material when away from the office, home or other location where the user normally prints such documents.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to various modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A combination laptop computer and printer, comprising:
a laptop computer having a base and a lid pivotally attached to said base; and
a printer integrally formed with or attached to said laptop computer and disposed below said base or above said lid, said printer comprising a printing apparatus configured to print on a sheet of paper and a pull/feed mechanism configured to direct said sheet of paper to said printing apparatus and to eject said sheet of paper out of said printer.

2. The combination laptop computer and printer according to claim 1, wherein said printer has an intake slot and an opposite facing discharge slot, said pull/feed mechanism configured to pull said sheet of paper into said printer through said intake slot, feed said sheet of paper to said printing apparatus and eject said sheet of paper out of said printer through said discharge slot.

3. The combination laptop computer and printer according to claim 1, wherein said printer has a first end, a second end, a front side and a back side, said front side of said printer in corresponding relation with a front side of said laptop computer, said intake slot on said first end of said printer and said discharge slot on said second end of said printer.

4. The combination laptop computer and printer according to claim 1, wherein said printer has a first end, a second end, a front side and a back side, said front side of said printer in corresponding relation with a front side of said laptop computer, said intake slot on said front side of said printer and said discharge slot on said back side of said printer.

5. The combination laptop computer and printer according to claim 1, wherein said printer apparatus comprises a printer head and a replaceable ink cartridge removably received in an ink compartment.

6. The combination laptop computer and printer according to claim 1, wherein said laptop computer comprises an on/off device configured to activate said laptop computer and said printer.

7. The combination laptop computer and printer according to claim 1, wherein said laptop computer comprises a power receptacle configured to connect said laptop computer and said printer to a source of power.

8. The combination laptop computer and printer according to claim 1, wherein said printer has a lower wall fixedly attached to or integral with an upper surface of said lid so as to result in said laptop computer and said printer being fixedly joined.

9. The combination laptop computer and printer according to claim 1, wherein said printer has an upper wall fixedly attached to or integral with a lower surface of said base so as to result in said laptop computer and said printer being fixedly joined.

10. The combination laptop computer and printer according to claim 1, wherein each of said intake slot and said discharge slot are at least 8½″ wide so as to allow said printer to print letter and/or legal sized paper.

11. The combination laptop computer and printer according to claim 1 further comprising a scanning mechanism disposed in said printer, said scanning mechanism configured to selectively scan said sheet of paper.

12. The combination laptop computer and printer according to claim 1, wherein said laptop computer and said printer are electrically and electronically connected to function as a single integral unit that does not require any external connectors to operate together.

13. A combination laptop computer and printer, comprising:
a laptop computer having a base and a lid pivotally attached to said base, said lid having an upper surface; and
a printer integrally disposed below said laptop computer and electrically and electronically connected with said laptop computer to function together, said printer having an intake slot and an opposite facing discharge slot, said printer further comprising a printing apparatus configured to print on a sheet of paper and a pull/feed mechanism configured to pull said sheet of paper into said printer through said intake slot, feed said sheet of paper to said printing apparatus and eject said sheet of paper out of said printer through said discharge slot.

14. The combination laptop computer and printer according to claim 13, wherein said printer apparatus comprises a printer head and an ink cartridge, said ink cartridge removably disposed in an ink compartment, said pull/feed mechanism having a plurality of rollers configured to engage said sheet of paper as it moves through said printer.

15. The combination laptop computer and printer according to claim 13, wherein said laptop computer comprises an on/off device configured to activate said laptop computer and said printer.

16. The combination laptop computer and printer according to claim 13, wherein said laptop computer comprises a power receptacle configured to connect said laptop computer and said printer to a source of power.

17. The combination laptop computer and printer according to claim 13 further comprising a scanning mechanism disposed in said printer between said intake slot and said discharge slot, said scanning mechanism configured to selectively scan said sheet of paper inserted into said printer through said intake slot.

18. A combination laptop computer and printer, comprising:
a laptop computer having a base, a lid pivotally attached to said base, said lid having an upper surface;
a printer integrally disposed below said laptop computer and electrically and electronically connected with said laptop computer to function together, said printer comprising a printing apparatus configured to print on a sheet of paper and a pull/feed mechanism configured to pull said sheet of paper into said printer, feed said sheet of paper to said printing apparatus and eject said sheet of paper out of said printer;
an on/off device on one of said laptop computer and said printer, said on/off device configured to activate said laptop computer and said printer; and
a power receptacle on one of said laptop computer and said printer, said power receptacle configured to connect said laptop computer and said printer to a source of power.

19. The combination laptop computer and printer according to claim 18 further comprising a scanning mechanism disposed in said printer between an intake slot and a discharge slot, said scanning mechanism configured to scan said sheet of paper inserted into said printer through said intake slot.

20. The combination laptop computer and printer according to claim 18 further comprising a paper tray integrally disposed below said printer.
